(19) United States
(12) Patent Application Publication
(10) Pub. No.: US 2025/0061331 A1
(43) Pub. Date: Feb. 20, 2025

(54) METHOD AND COMPUTER-READABLE STORAGE MEDIUM FOR GENERATING HIT REACTION ON BASIS OF TRAINED NEURAL NETWORK

(71) Applicants: NCSOFT Corporation, Seoul (KR); Seoul National University R & DB FOUNDATION, Seoul (KR)

(72) Inventors: Soohwan PARK, Seoul (KR); Namil LEE, Seongnam-si (KR); Insub IM, Seongnam-si (KR); Hyoil LEE, Seongnam-si (KR); Jehee LEE, Seoul (KR)

(73) Assignees: NCSOFT Corporation, Seoul (KR); Seoul National University R & DB FOUNDATION, Seoul (KR)

(21) Appl. No.: 18/936,335

(22) Filed: Nov. 4, 2024

Related U.S. Application Data
(63) Continuation of application No. PCT/KR2022/006495, filed on May 6, 2022.

(51) Int. Cl. G06N 3/08; A63F 13/67

(52) U.S. Cl. CPC G06N 3/08; A63F 13/67

(57) ABSTRACT

A computer-readable storage medium according to an embodiment may store one or more programs, wherein the one or more programs include instructions, when executed by a processor of an electronic device, to cause the electronic device to: provide first training data to a first neural network for learning actions of an object; perform data sampling on hit reaction data so as to identify second training data; provide the second training data to a second neural network for learning a hit reaction of the object; and when the object is hit, acquire a result of the hit reaction of the object on the basis of the output of the first neural network and the second neural network. Various other embodiments are possible.

### CROSS-REFERENCE TO RELATED APPLICATION

This application is a Continuation Application of International Application PCT/KR2022/006495 filed on May 6, 2022, at the Korean Intellectual Property Office, the disclosure of which is incorporated by reference in its entirety.

### BACKGROUND

### 1. Field

The following disclosure relates to a method and a computer-readable storage medium for generating a hit reaction based on a trained neural network.

### 2. Description of Related Art

The quality of a hit reaction, which is a reaction operation to an attack, is important in order to improve a visual quality of a battle in a game. However, research on the hit reaction has been insufficient. In most games, the hit reaction has been implemented by outputting a random hit animation according to a set condition. An operation according to a hit is affected by a variety of conditions compared to other general operations. For example, an operation according to the hit is affected by a physical condition as well as a spatial condition.

There have been an effort to naturally synthesize an operation by training a neural network with data obtained by a motion capture method. However, in a real time streaming situation, training is not easy with only the motion capture method due to limited time.

A neural network may mean a model having an ability to solve a problem by changing a coupling strength of synapses based on training nodes that form a network through coupling of the synapses. The neural network may be trained through supervised learning or unsupervised learning.

### SUMMARY

Embodiments of the present disclosure provide a device and a method for more accurately deriving a result according to a hit reaction through a neural network for hit reaction learning. Embodiments of the present disclosure provide a device and a method for efficiently performing learning of a hit reaction by identifying data for hit reaction learning.

The technical problems to be achieved in the present disclosure are not limited to those described above, and other technical problems not mentioned herein will be clearly understood by those having ordinary knowledge in the art to which the present disclosure belongs, from the following description.

According to an embodiment, a computer readable storage medium may store one or more programs, the one or more programs may include instructions that, when executed by a processor of an electronic device, cause the electronic device to provide to a first neural network for training operations of an object, first training data, identify second training data, by performing data sampling regarding hit reaction data, provide to a second neural network for training a hit reaction of the object, the second training data, and obtain a result of the hit reaction of the object, in case that the object is hit based on an output of the first neural network and an output of the second neural network.

According to an embodiment, a method executed in an electronic device may comprise providing to a first neural network for training operations of an object, first training data, identifying second training data, by performing data sampling regarding hit reaction data, providing, to a second neural network for training a hit reaction of the object, the second training data, and obtaining a result of the hit reaction of the object, in case that the object is hit based on an output of the first neural network and an output of the second neural network.

A device and a method according to embodiments of the present disclosure can efficiently train a neural network for a hit reaction by sampling a generated hit reaction data and identifying training data, and provide various hit reactions.

The effects that can be obtained from the present disclosure are not limited to those described above, and any other effects not mentioned herein will be clearly understood by those having ordinary knowledge in the art to which the present disclosure belongs, from the following description.

### BRIEF DESCRIPTION OF DRAWINGS

FIG. 1 illustrates an example of a hit reaction according to embodiments.

FIG. 2 illustrates an example of a functional configuration of an electronic device according to embodiments.

FIG. 3 illustrates an operation flow of an electronic device for deriving a result of a hit reaction based on an adaptive hit reaction neural network according to embodiments.

FIG. 4 illustrates an operation flow of an electronic device for deriving a result of a hit reaction based on an adaptive hit reaction neural network according to embodiments.

FIG. 5 illustrates an operation flow of an electronic device for learning an adaptive hit reaction neural network according to embodiments.

FIG. 6 illustrates an example of generating hit reaction data based on raw data according to an embodiment.

FIG. 7A illustrates an example of sampling of hit reaction data according to embodiments.

FIG. 7B illustrates an example of sampling based on an amount of change of hit reaction data according to embodiments.

FIG. 7c illustrates an example of sampling based on an initial posture of hit reaction data according to embodiments.

FIG. 8 illustrates an example of an adaptive hit reaction neural network according to embodiments.

FIG. 9 illustrates examples of a hit reaction according to embodiments.

FIG. 10 illustrates an example of a comparison according to whether or not sampling hit reaction data according to embodiments.

FIG. 11 illustrates an example of performance improvement of an adaptive hit reaction neural network according to embodiments.

### DETAILED DESCRIPTION

The terms used in the present disclosure are used only to describe a specific embodiment and may not be intended to limit scope of another embodiment. Terms used herein, including a technical or scientific term, may have a same meaning as generally understood by those skilled in an art described in the present disclosure. Among the terms used in the present disclosure, terms defined in a general dictionary may be interpreted as having a same or similar meaning as a contextual meaning of a related technology and are not interpreted in an ideal or overly formal meaning unless explicitly defined in the present disclosure. In some cases, even a term defined in the present disclosure should not be interpreted to exclude embodiments of the present disclosure.

Hereinafter, the present disclosure relates to a device and a method for generating an appropriate hit reaction operation according to various hit conditions in real time in a wireless communication system. Specifically, the present disclosure describes a technology for efficiently outputting a reaction operation to a hit through a neural network for learning hit reaction data. In the present disclosure, in order to determine whether a specific condition is satisfied or fulfilled, expressions of more than or less than may be used, however this is only a description for expressing an example and does not exclude descriptions of more than or less than. A condition written as ‘more than or equal to’ may be replaced with ‘more than’, a condition written as ‘less than or equal to’ may be replaced with ‘less than’, and conditions written as ‘more than or equal to and less than’ may be replaced with ‘more than and less than or equal to’.

In the following description, a term (e.g., a target object, a hit method, a hit means, a hit part) referring to a variable related to a movement, a term (e.g., a neural network, a generator) referring to a of a device, and so on are exemplified for convenience of a description. Therefore, the present disclosure is not limited to terms described below, and another term having equivalent technical meanings may be used.

Various embodiments of the present disclosure and terms used herein are not intended to limit a technology described in the present disclosure to a specific embodiment, but should be understood to include various changes of the corresponding embodiment, equivalents and/or substitutes. Related to a description of a drawing, a similar reference numeral may be used for a similar component. A singular expression may include a plural expression unless a context clearly indicates otherwise. In the present disclosure, an expression such as “A or B”, “at least one of A and/or B”, “A, B or C”, or “at least one of A, B and/or C”, and so on may include all possible combinations of items listed together. Expressions such as “1st”, “2nd”, “first”, or “second”, and so on may modify corresponding components regardless of order or importance, and are only used to distinguish a component from another component, but do not limit the corresponding components. When a component (e.g., a first component) is mentioned as being “(functional or communicatively) connected” or “accessed” to another component (e.g., a second component), the component may be connected directly to the other component, or may be connected through another component (e.g., a third component).

A term “module” used in the present disclosure may include a unit configured as hardware, software, or firmware, and so on, and may be used interchangeably with terms such as logic, a logical block, a part or a circuit, for example. The module may be an integrated constituent or a minimal unit or a portion thereof that performs one or more functions. For example, a module can be configured as an application-specific integrated circuit (ASIC).

According to embodiments of the present disclosure, an electronic device may be a device of various forms. The electronic device may include, for example, a portable communication device (e.g., a smartphone), a computer device, a portable multimedia device, a portable medical device, a camera, a wearable device, or a home electronic device. According to an embodiment of the present disclosure, the electronic device is not limited to the above-described devices.

Embodiments of the present disclosure may be implemented as software (e.g., a program) including one or more commands stored in a storage medium (e.g., an internal memory or an external memory) readable by a machine (e.g., an electronic device 210). For example, a processor of the machine may call at least one of the one or more instructions stored from the storage medium and it may be executed. This enables the machine to be operated to perform at least one function according to the at least one command called. The one or more commands may include code generated by a compiler or code executable by an interpreter. A storage medium readable by the machine may be provided in a form of a non-transitory storage medium. Here, ‘non-transitory’ only means that the storage medium is a tangible device and does not contain a signal (e.g., an electromagnetic wave), and this term does not distinguish between when data is stored semi-permanently and when it is temporarily stored.

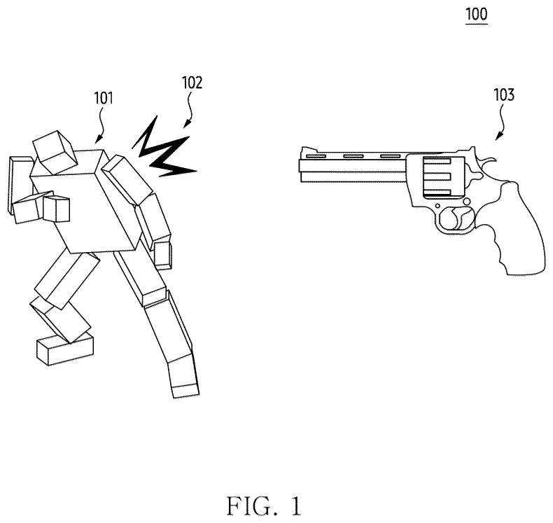

FIG. 1 illustrates an example of a hit reaction according to embodiments and a neural network for learning the hit reaction of the present disclosure and procedures for obtaining a result for the hit reaction through the neural network are described.

Referring to FIG. 1, the hit reaction means a reaction of an object corresponding to a hit 102 when an object 101 receives a hit 102 from another object 103. Although FIG. 1 shows a gun, a hit means 103 may be a sword, a cannon, an arm, a foot, or any other object through which the hit 102 is transmitted to the object 101. For example, in FIG. 1, the object 101 receives the hit 102 by a bullet shot from weapon 103. A reaction of the object 101 corresponding to a shooting may be the hit reaction. For example, the hit reaction may mean a reaction operation when the object 101 in a virtual environment (e.g., a game) is attacked by another object 103 by the hit 102. For a high quality of a service provided in a virtual environment, the hit reaction requires plausibility and realism. In the present disclosure, a device and a method for an object 101 to output an appropriate hit reaction in response to a hit are described. In particular, in the present disclosure, learning about a hit of the object 101, the neural network for the learning, and a device and a method using the neural network are described. A state of the object 101 may be changed according to a hit condition.

For example, the state of object 101 may include a location of the object 101. For example, the location of object 101 may be changed from a first location to a second location based on a hit 102 from another object 103.

For example, the state of the object 101 may include a moving direction. For example, based on the hit 102 from the other object 103, a direction of the object 101 may be changed from a first direction to a second direction.

For example, the state of the object 101 may include a posture of the object 101. The posture of the object 101 may be changed from a first posture to a second posture based on the hit from the other object 103. In other words, the hit 102 of from other object 103 may be used in a virtual environment to change at least one of the location, the direction, or the posture of the object 101. Although not shown in FIG. 1, the state of the object 101 may include all external factors such as a facial expression of the object 101, whether the object 101 is bleeding, and a costume change of the object 101.

The object 101 may have a plurality of states. The plurality of states may be represented in a virtual environment through a motion of the object 101. The motion of the object 101 describes in an embodiment, that a state of the object 101 is changed. For a high quality of a service provided in the virtual environment, states configuring a motion of the object 101 are required to be more numerous and more accurate.

To describe the hit reaction, it is assumed that a current state of object 101 is in a first state. In the first state, the object 101 may receive an attack (i.e., the hit 102). In response to the attack, the object 101 may be switched from the first state to a second state through at least one third state. A motion of switching from the first state to the second state through at least one third state is referred to as a hit reaction. For example, when a shoulder of a walking object 101 is shot at, the hit reaction may include a walking state as the first state, a state in which the shoulder is tilted as the third state, and a lying on a floor as the second state. In this case, the third state may be variously configured in one or more states according to a degree of shoulder twisting, a degree of being pushed, and so on.

The hit reaction may vary according to a hit condition. The hit condition may include an attack condition. According to an embodiment, the attack condition may include an attack means. For example, an object may be attacked by a gun or a sword. For another example, the object 101 may be attacked from a body part such as a hand or a foot. For a plausible and realistic motion corresponding to a hit, an adaptive hit reaction is required according to which object the attack is received from. According to an embodiment, the attack condition may include attack intensity. For example, the hit reaction may vary according to whether it has been struck at intensity greater than a reference value for determining a fall.

The hit condition may include an object condition. The object condition may include a hit part, a hit range, and an initial posture of an object. For example, a hit reaction when another object 103 makes a hit 102 to a shoulder of the object 101 may be different from a hit reaction when another object makes the hit 102 to a waist of the object 101. A hit reaction when another object makes the hit 102 to one shoulder of the object 101 may be different from a hit reaction when another object makes the hit 102 to both shoulders of the object 101. A hit reaction when the hit 102 is made to the shoulder of the object 101 with intensity insufficient to cause a fall may be different from when the hit 102 is made to the shoulder of the object 101 with intensity sufficient to cause a fall. A hit reaction when another object makes the hit 102 to a standing object 101 may be different from a hit reaction when another object makes the hit 102 to a running object 101.

The present disclosure proposes a neural network for hit reaction learning in order to more accurately and effectively output the hit reaction described in FIG. 1. The neural network may mean a model having an ability to solve a problem by changing a coupling strength of synapses based on training nodes that form a network through the coupling of synapses. The neural network may be trained through supervised learning or unsupervised learning. For example, the supervised learning may mean learning performed by providing a label (or a correct answer). Since the supervised learning requires the label, less resources may be required than the unsupervised learning to evaluate reliability of output data derived from the neural network. On the other hand, since the supervised learning requires the label, resources (e.g., time resources) for obtaining the label may be required. For another example, the unsupervised learning may mean learning performed without a label. Since the unsupervised learning does not require the label, resources for obtaining the label may not be required. On the other hand, since the unsupervised learning does not require the label, more resources may be required than the supervised learning to evaluate reliability of the output data derived from the neural network.

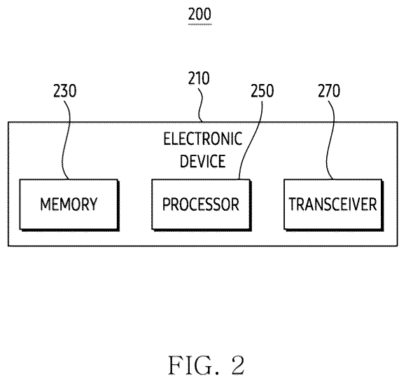

As described above, a relatively large amount of training data is required, in order to obtain an effective output for the reaction of the object. However, sufficient learning is not easy in a limited situation, such as a streaming environment within a specific device. Therefore, the present disclosure proposes an output of the hit reaction using a neural network to separately perform only learning for the hit reaction, by focusing on the hit reaction rather than an entire operation of an object. Hereinafter, components of an electronic device for implementing the neural network of the present disclosure are described through FIG. 2.

FIG. 2 illustrates an example of a functional configuration of an electronic device 210 according to embodiments. As mentioned in FIG. 1, a configuration illustrated in FIG. 2 may be understood as a configuration of the electronic device 210 for outputting a reaction of an object when the object is hit. The terms ‘ . . . unit’, ‘ . . . device’, and so on, used hereinafter mean a unit that processes at least one function or operation, which may be implemented as hardware or software or a combination of hardware and software.

Referring to FIG. 2, the electronic device 210 may include a memory 230, a processor 250, and a transceiver 270. The memory 230 may store data such as a basic program, an application program, setting information, and so on for an operation of the electronic device 210. The memory 230 may be referred to as another term having a same technical meaning, such as a storage unit or a storage medium. The memory 230 may be configured as a volatile memory, a nonvolatile memory, or a combination of the volatile memory and the nonvolatile memory. In addition, the memory 230 may provide stored data according to a request of the processor 250. According to embodiments, the memory 230 may store hit reaction data for operations and learning for driving an adaptive hit reaction neural network according to embodiments of the electronic device 210.

Embodiments of the present disclosure may be implemented as software (e.g., a program) including one or more instructions stored in a storage medium (e.g., an internal memory or an external memory) readable by a machine (e.g., the electronic device 210). For example, a processor (e.g., the processor 250) of the machine (e.g., the electronic device 210) may invoke at least one of the one or more instructions stored in the storage medium, and execute it. This enables the machine to be operated to perform at least one function according to the at least one instructions invoked. The one or more instructions may include a code generated by a compiler or a code executable by an interpreter. The machine readable storage medium may be provided in a form of a non-transitory storage medium. Herein, the term ‘non-transitory’ simply means that the storage medium is a tangible device and does not include a signal (e.g., an electromagnetic wave), and this term does not distinguish between a case in which data is semi-permanently stored in the storage medium and a case in which the data is temporarily stored in the storage medium.

The processor 250 may control overall operations of the electronic device 210. For example, the processor 250 may write and read data in the memory 230. Furthermore, the processor 250 may transmit and receive a signal through the transceiver 270. In addition, the processor 250 may perform functions of a protocol stack required by a communication standard. To this end, the processor 250 may include at least one sub-processor. According to embodiments, the processor 250 may be configured so that the electronic device 210 performs an output operation according to the adaptive hit reaction neural network according to embodiments and a learning operation of the neural network.

The transceiver 270 may perform functions for transmitting and receiving a signal in a wired communication environment. The transceiver 270 may include a wired interface for controlling a direct connection between a device and another device through a transmission medium (e.g., a copper wire, an optical fiber). For example, the transceiver 270 may transmit an electrical signal to another device through a copper wire or perform conversion between an electrical signal and an optical signal.

The transceiver 270 may perform functions for transmitting and receiving a signal through a wireless channel. For example, the transceiver 270 may perform a conversion function between a baseband signal and a bit stream according to a physical layer specification of a system. For example, when transmitting data, the transceiver 270 may generate complex symbols by encoding and modulating a transmission bit stream. Furthermore, when receiving data, the transceiver 270 may restore a baseband signal to a reception bit stream by demodulating and decoding. Furthermore, the transceiver 270 may up-convert a baseband signal to a radio frequency (RF) band signal and subsequently transmit through an antenna, and down-convert the RF band signal received through the antenna to the baseband signal. To this end, the transceiver 270 may include a transmission filter, a reception filter, an amplifier, a mixer, an oscillator, a digital-to-analog converter (DAC), an analog-to-digital converter (ADC), and so on.

Furthermore, the transceiver 270 may include a plurality of transmit/receive paths. Moreover, the transceiver 270 may include at least one antenna array configured as a plurality of antenna elements. In terms of hardware, the transceiver 270 may be configured as a digital unit and an analog unit, and the analog unit may be configured as a plurality of sub-units according to operating power, an operating frequency, and so on.

The transceiver 270 may transmit and receive the signal as described above. Accordingly, all or a portion of the transceiver 270 may be referred to as a ‘transmission unit’, a ‘reception unit’, or a ‘transmission/reception unit’. Furthermore, in the following description, transmission and reception performed through a wireless channel may be used as a meaning including that processing as described above is performed by the transceiver 270.

The configuration of the electronic device 210 illustrated in FIG. 2 is only an example, and an example of an electronic device that performs various embodiments of the present disclosure is not limited to the configuration shown in FIG. 2. In other words, according to various embodiments, some configuration may be added, removed, or changed. For example, in a case of a device that performs both learning about a hit reaction and deriving a result about a hit reaction inside the electronic device 210, the transceiver 270 may be omitted from the electronic device 210.

A set of a neural network and parameters related to the neural network may be stored in the memory 230 of the electronic device 210 according to an embodiment. A neural network is a cognitive model implemented in software or hardware that mimics a computational capabilities of a biological system by using a large number of artificial neurons (or nodes). The neural network may perform human cognitive action, a learning process, or training through artificial neurons. The parameters related to the neural network, for example, may indicate a weight assigned to a plurality of nodes included in the neural network and/or a connection between the plurality of nodes.

In an embodiment, the processor 250 may train the neural network. In an embodiment, the neural network may be trained through the unsupervised learning. In an embodiment, the processor 250 may provide input data to the neural network to train the neural network. For example, the input data may be training data generated by hit reaction data sampling.

For example, the neural network may include a plurality of layers. For example, the neural network may include an input layer, one or more hidden layers, and an output layer. Signals caused by each of nodes in the input layer based on the input data may be transmitted from the input layer to the one or more hidden layers. Based on one or more signals received from the one or more hidden layers, the output layer may obtain output data of the neural network.

Meanwhile, the input layer, the one or more hidden layers, and the output layer may include a plurality of nodes. The one or more hidden layers may be a convolution filter or a fully connected layer in a convolution natural network (CNN), or various types of filters or layers connected based on a specific function or feature. In an embodiment, the one or more hidden layers may be a layer based on a recurrent natural network (RNN) in which an output value is inputted back to a hidden layer of a current time. In an embodiment, the one or more hidden layers may be configured in a plural, and may form a deep neural network. For example, training a neural network including the one or more hidden layers that form at least a portion of the deep neural network may be referred to as a deep learning.

A node included in the one or more hidden layers may be referred to as a hidden node.

Nodes included in the input layer and the one or more hidden layers may be connected to each other through a connection line having a connection weight, and nodes included in the one or more hidden layers and the output layer may also be connected to each other through the connection line having the connection weight. Tuning and/or training the neural network may mean changing the connection weight between nodes included within each of layers (e.g., the input layer, the one or more hidden layers, and the output layer) included in the neural network. For example, tuning or training of the neural network may be performed based on the unsupervised learning.

According to an embodiment, a method according to various embodiments of the present disclosure may be included and provided in a computer program product. The computer program product may be traded as a product between a seller and a buyer. The computer program product may be distributed in a form of a machine-readable storage medium (e.g., compact disc read only memory (CD-ROM)), or be distributed (e.g., downloaded or uploaded) online through an application store (e.g., PlayStore™), or between two user devices (e.g., smart phones) directly. In a case of online distribution, at least a portion of the computer program product may be temporarily generated or at least temporarily stored in the machine-readable storage medium, such as memory of a server of a manufacturer, a server of the application store, or a relay server.

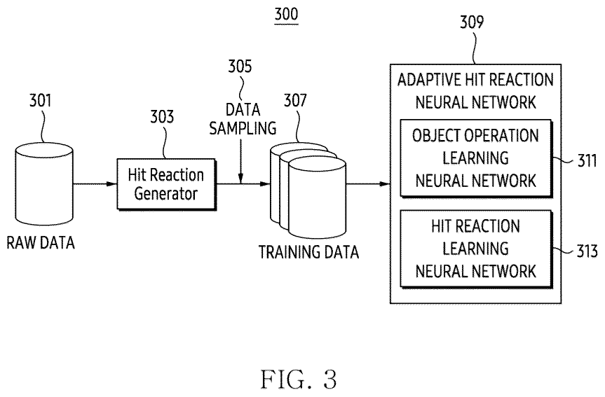

FIG. 3 illustrates an example of learning an adaptive hit reaction according to embodiments. Hereinafter, operations of FIG. 3 are described as being performed by the processor 250 of the electronic device 210 of FIG. 2, but embodiments of the present disclosure are not limited thereto. According to another embodiment, a partial operation(s) among operations described below may be performed by the processor 250 of the electronic device 210, and another partial operation(s) may be performed through an external device (e.g., an over the air (OTA) server) through a transceiver 270 of the electronic device 210. According to another embodiment, a partial operation(s) among operations described below may be implemented in advance in a memory 230 of the electronic device 210, and another partial operation(s) may be performed by the processor 250 of the electronic device 210.

Referring to FIG. 3, learning of the adaptive hit reaction may be performed through hit reaction generation, data sampling, and hit reaction learning.

The processor 250 may obtain raw data 301. For example, the processor 250 may obtain the raw data 301 from the memory 230. For another example, the processor 250 may obtain the raw data 301 from an external server. The raw data 301 may mean all data related to an object. For example, the raw data 301 may include motion capture data.

The processor 250 may generate a hit reaction. A command performed by the processor 250 to generate the hit reaction or an operation of the processor 250 generating the hit reaction may be understood as a function of a hit reaction generator 303. The hit reaction generator 303 may generate the hit reaction based on the raw data 301. In order to learn data having a feature in which there are a large number of various operations, at a moment of a hit, a hit reaction data is required. In order to obtain the data, the hit reaction generator 303 may generate various hit reactions. The hit reaction generator 303 may generate various hit reaction data on a given hit condition through the raw data 301.

According to an embodiment, the hit reaction generator 303 may output hit reaction data based on the raw data 301, which is motion data. For example, the raw data 301 may include motion data according to a specified hit angle. For example, the raw data 301 may include motion data according to a specified hit part (e.g., head).

According to an embodiment, the hit reaction generator 303 may generate a hit reaction based on a recognition reaction mechanism. For example, the hit reaction generator 303 may implement an operation using a physical simulation during a defined time after an impact, and may find appropriate motion from a motion database after the defined time and output it. For example, raw data may be motion capture data hitting the head. When the raw data, a hit angle (e.g., vertical), and a hit part (e.g., head) are input data, the hit reaction generator 303 may generate hit reaction data based on the input data. The hit reaction generator 303 may generate hit reaction data based on an instantaneous hit reaction and a subsequent hit reaction. For example, the hit reaction generator 303 may generate hit reaction data by connecting the instantaneous hit reaction when a head is moved by force during a defined time and the subsequent hit reaction through a motion matching after the instantaneous hit reaction. For example, the hit reaction data may be an operation of the head falling backward first in the instantaneous reaction state and falling while flailing a hand to keep balance in the subsequent reaction state.

The hit reaction generator 303 may generate a hit reaction for continuous hit conditions based on hit reaction data for a diasporic hit condition. For example, in case that only hit reaction data for a condition of striking a shoulder with magnitude of first force and hit reaction data for a condition of striking a shoulder with magnitude of second force exist, the hit reaction generator 303 may generate hit reaction data for a condition of striking with magnitude of third force between the magnitude of the first force and the magnitude of the second force. For example, in case that only hit reaction data for a condition of attacking a shoulder with a sword having a first length and hit reaction data for a condition of attacking a shoulder with a sword having a second length exist, the hit reaction generator 303 may generate hit reaction data for a condition of attacking with a sword of a third length between the first length and the second length. For example, in case that only hit reaction data for a condition of attacking a first part within a head and hit reaction data for a condition of attacking a second part within the head exist, the hit reaction generator 303 may generate hit reaction data for a condition of attacking a third part between the first part and the second part.

Data sampling 305 describes in an embodiment, a process of identifying training data 307 from the hit reaction data. When all hit reaction data is inputted to an adaptive hit reaction neural network 309, a burden on the adaptive hit reaction neural network 309 increases. The more data is trained, relatively more resources of the processor 250 are consumed. Additionally, when real-time output such as streaming is required, outputting a result according to learning within a limited time may not be easy. Therefore, the processor 250 may remove hit reaction data that falls short of at least one or more references from the training data 307, through the data sampling 305, in order to efficiently train the adaptive hit reaction neural network 309. For example, data sampling 507 may be performed through an algorithm for removing hit reaction data for at least one of an initial posture, an attack part, an attack range, and/or attack intensity having an amount of change of less than or equal to a reference value.

The adaptive hit reaction neural network 309 may be configured as at least one neural network. The adaptive hit reaction neural network 309 may be referred to as a Diversity-Adaptive Refinement Network. According to embodiments, the adaptive hit reaction neural network 309 may be configured as an object operation learning neural network 311 and a hit reaction learning neural network 313. The object operation learning neural network 311 is a neural network for learning an operation of an object. The object operation learning neural network 311 may be referred to as a first subnetwork, a first neural network, or a regular subnetwork. The hit reaction learning neural network 313 is a neural network for learning a hit reaction. The hit reaction learning neural network 313 may be referred to as a second subnetwork, a second neural network, a hit reaction subnetwork, or a hit subnetwork. The adaptive hit reaction neural network 309 is configured as the object operation learning neural network 311 and the hit reaction learning neural network 313, in order to obtain an accurate result value. A neural network of this structure may output a more accurate and abundant hit reaction.

According to an embodiment, a gating module, which couple output results of the object operation learning neural network 311 and the hit reaction learning neural network 313, may be further added to the adaptive hit reaction neural network 309.

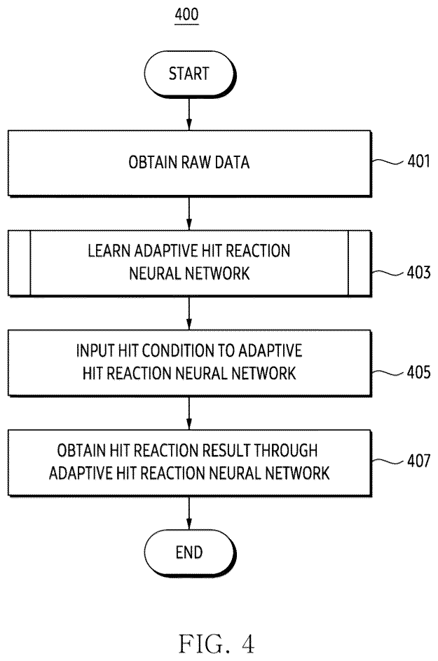

FIG. 4 illustrates an operation flow of an electronic device for deriving a result of a hit reaction based on an adaptive hit-reaction neural network according to embodiments. The electronic device exemplifies the electronic device 210 of FIG. 2. At least a portion of operations of FIG. 4 may be executed by the processor 250 of the electronic device 210.

Referring to FIG. 4, in an operation 401, the electronic device 210 may obtain raw data, in order to generate hit reaction data. The raw data describes in an embodiment, data about an operation of an object. For example, the raw data may include motion capture data. For example, the raw data may be fall motion capture data of an object attacked on a shoulder.

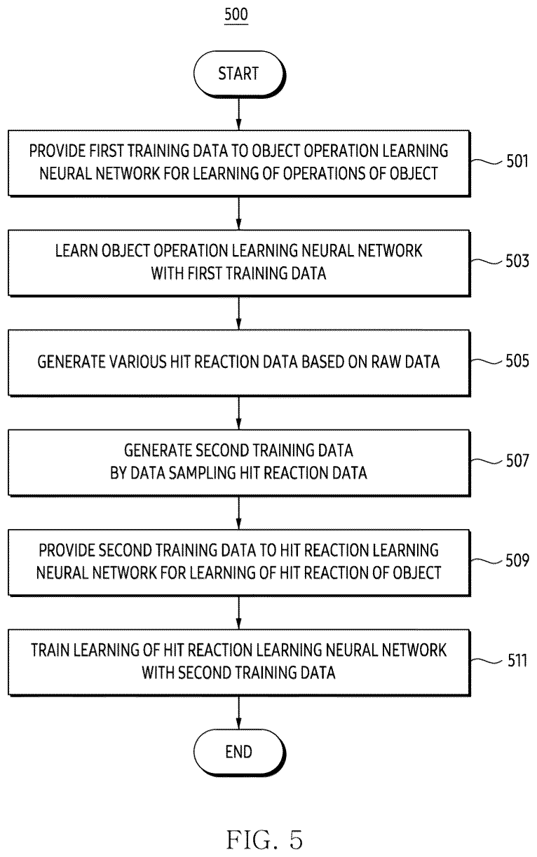

In an operation 403, the electronic device 210 may perform learning of the adaptive hit reaction neural network. Neural network training based on raw data may include content illustrated in FIG. 5. For example, the electronic device 210 generates at least one or more hit reaction data based on the raw data (505). Thereafter, the electronic device 210 may generate training data through a process of sampling the hit reaction data (509), and train a hit reaction learning neural network based on training data (511).

In operation 405, the electronic device 210 may input a hit condition to the adaptive hit reaction neural network. The electronic device 210 may provide the hit condition to the learned neural network as input data (405) and obtain a hit reaction result of an object based on an neural network output (407). For example, the hit condition may be information on an attack condition, an object condition, and so on.

According to an embodiment, in an operation 405, when an object is hit, a hit condition may be inputted to a neural network. Herein, the hit condition, which is input data, may be given as a motion. The processor 250 may extract content about the hit condition by analyzing the motion. When input data is a motion of shooting an object in a standing state from the front perpendicular to a plane constituting a human body, the processor 250 may extract that an initial posture is in the standing state. Furthermore, the processor 250 may extract that a hit method is the shooting, and a hit angle is the front perpendicular to the plane constituting the human body.

In operation 407, the electronic device 210 may obtain a hit reaction result from the adaptive hit reaction neural network. The adaptive hit reaction neural network may be configured as at least one or more neural networks. For example, an adaptive hit reaction neural network 309 may be configured as an object operation learning neural network 311 and a hit reaction learning neural network 313. For example, the adaptive hit reaction neural network 309 may determine a hit reaction result in operation 407 by considering a weight assigned to output of the object operation learning neural network 311 and output of the hit reaction learning neural network 313.

The weight assignment may be performed based on a coupling gating module 805. The gating module 805 may be a neural network. The gating module 805 may be the neural network that receives a hit condition as input data and outputs the weight assigned to the output of the object operation learning neural network 311 and the output of the hit reaction learning neural network 313.

In an embodiment, in operation 407, the gating module 805 may determine the weight assigned to the output of the object operation learning neural network 311 and the output of the hit reaction learning neural network 313 based on hit intensity. For example, as the hit intensity is stronger, it is determined that the weight assigned to the output of the hit reaction learning neural network 313 is higher. When an object is attacked on a shoulder from another object, as the hit intensity is lower, the gating module may assign a higher weight to the output of the object operation learning neural network 311 than the output of the hit reaction learning neural network 313. In this case, magnitude of an operation of motion of not falling even when attacked on a shoulder and flailing may be reduced in the hit reaction. For example, in operation 407, only when there is an attack operation of another object, a hit reaction result may be obtained by considering an output result of the hit reaction learning neural network. For example, when an object interacts with an environment, the output result of the hit reaction learning neural network may not be considered. For example, in case that a strong wind is blowing vertically forward on a character, an output value of the hit reaction learning neural network may not be considered when generating a reaction of an object.

In FIG. 4, the operation 401, the operation 403, the operation 405, and the operation 407 are illustrated to be performed sequentially, but embodiments of the present disclosure are not limited thereto. According to an embodiment, the operation 401 and the operation 403 for learning a hit reaction may be performed in parallel with the operation 405 and the operation 407 for outputting a result for the hit reaction. According to another embodiment, the operation 401 and the operation 403 are performed periodically, but the operation 405 and the operation 407 may be performed only when an object is hit.

FIG. 5 illustrates an operation flow of an electronic device for learning an adaptive hit reaction neural network according to embodiments. The electronic device exemplifies the electronic device 210 of FIG. 2. At least a portion of operations of FIG. 5 may be executed by a processor 250 of the electronic device 210. Operations of FIG. 5 may be understood as specific operations of learning an adaptive hit reaction neural network of the operation 403 of FIG. 4.

Referring to FIG. 5, in an operation 501, the electronic device 210 may provide first training data to an object operation learning neural network for learning operations of an object. The object operation learning neural network may mean a neural network for learning all operations of an object. The first training data may include data about a hit reaction, as well as data related to operations of an object, such as a movement of the object, a state of the object, and an environment of the object.

In an operation 503, the electronic device 210 may learn the object operation learning neural network with the first training data. The first training data may be general motion capture data. When training a hit reaction learning neural network based on the raw data, the hit reaction learning neural network may be configured by being divided into the object operation learning neural network and a hit reaction learning neural network. According to an embodiment, an object operation learning neural network for learning all operations of an object may be trained with the first training data.

In an operation 505, the electronic device 210 may generate various hit reaction data based on raw data. The hit reaction data may include instantaneous hit reaction data and subsequent hit reaction data based on a recognition reaction mechanism. The instantaneous hit reaction may mean a hit reaction according to force applied to an object. The subsequent hit reaction may mean a hit reaction according to input of an object.

In an operation 507, the electronic device 210 may generate second training data by data sampling the hit reaction data. In order to extract efficient training data, the electronic device 210 may perform data sampling according to embodiments. According to an embodiment, the data sampling may be performed through an algorithm for removing hit reaction data having an amount of change equal to or less than a reference value. For example, the data sampling may be performed through an algorithm for removing hit reaction data for a hit part having an amount of change equal to or less than a reference value. When there already exist numerous hit reaction data in which a hit part is a shoulder in training data, the hit reaction data in which the hit part is the shoulder may no longer be added to the training data. For example, the data sampling may be performed through an algorithm for removing hit reaction data for a hit range having an amount of change equal to or less than a reference value. In case of a cutting operation with a sword, a hit range may vary according to a length of the sword. In case that a difference between a length of a sword of secured hit reaction data and a length of a sword of a target hit reaction is less than or equal to a reference value, target hit reaction data may not be added to training data. For example, the data sampling may be performed through an algorithm for removing hit reaction data for a hit part and hit intensity having an amount of change equal to or less than a reference value. For example, when training data includes hit reaction data in a case of attacking a shoulder of at least one object in a standing state, the hit reaction data in a case of attacking the shoulder of the object in the standing state with hit intensity less than or equal to a reference value may not be added to the training data.

In an operation 511, the electronic device 210 may train a hit reaction learning neural network with the second training data. The second training data may be different from the first training data. The second training data may be data sampled from hit reaction data. By extracting and sampling only data related to hit reaction, efficient learning is possible.

In FIG. 5, the operation 501 to the operation 511 are illustrated to be performed sequentially, but embodiments of the present disclosure are not limited thereto. According to an embodiment, the operation 501 and the operation 503 for learning the object operation learning neural network may be performed in parallel with the operation 505, the operation 507, the operation 509, and the operation 511 for learning the hit reaction learning neural network.

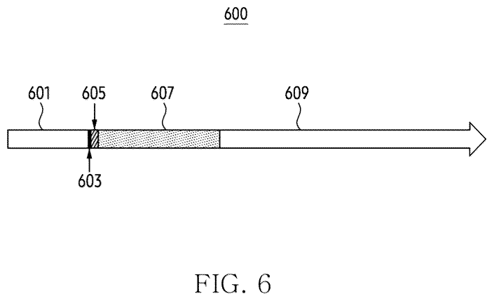

FIG. 6 illustrates an example of generating hit reaction data based on raw data according to an embodiment. The hit reaction data describes in an embodiment, information related to a reaction of an object when the object is hit. The electronic device 210 may generate the hit reaction data.

Referring to FIG. 6, a state of an object before being hit may be referred to as an idle state 601. Thereafter, from a time when the object is a hit 603, the state of the object transitions from the idle state 601 to a reaction state. After the reaction state, the object may transition back to an idle state 609. The reaction state may include an instantaneous reaction state 605 and a subsequent reaction state 607. A distinction between the instantaneous reaction state 605 and the subsequent reaction state 607 may be based on a recognition reaction mechanism. The recognition reaction mechanism is a principle that a reaction occurs after a delay of approximately 100 to 200 ms, when a living organism receives an unexpected and sudden impact.

The instantaneous reaction state 605 may be a state in which an operation due to a physical force occurs for a certain time immediately after the hit 603. The operation may be referred to as an instantaneous hit operation. The subsequent reaction state 607 may be a state in which an operation based on a will and a characteristic of a living organism occurs after the instantaneous reaction state 605. The operation may be referred to as a subsequent hit operation. The hit reaction data may include data related to the instantaneous hit operation and the subsequent hit operation described above.

In the subsequent reaction state 607, a hit reaction may be generated through a motion matching algorithm based on motion data. A hit reaction generator 303 of the electronic device 210 may find a motion corresponding to a hit from a motion database and output the motion. For example, when an object is attacked in a head, hit reaction data may include an operation of the head falling backward first in the instantaneous reaction state 605, and falling while flailing a hand to keep balance in the subsequent reaction state 607. Using a hit reaction data generation method of FIG. 6, the hit reaction generator 303 may generate various hit reaction data.

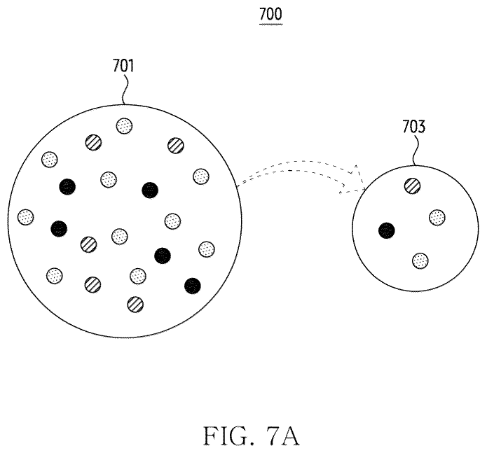

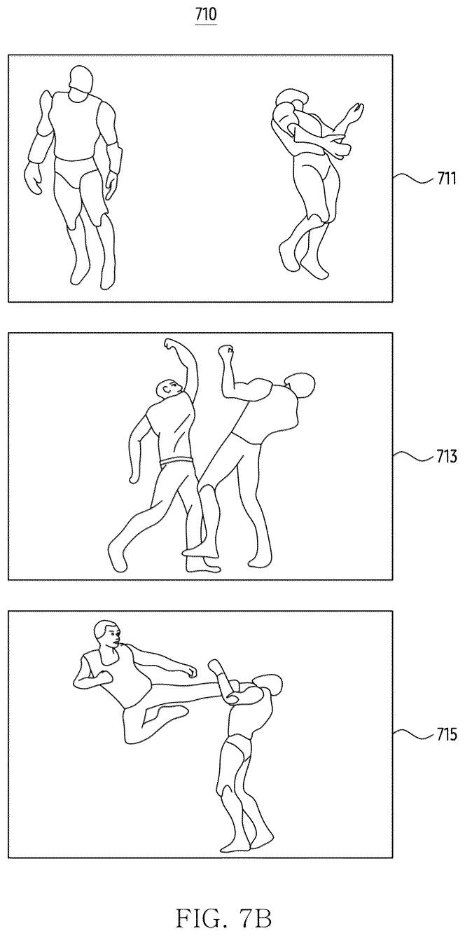

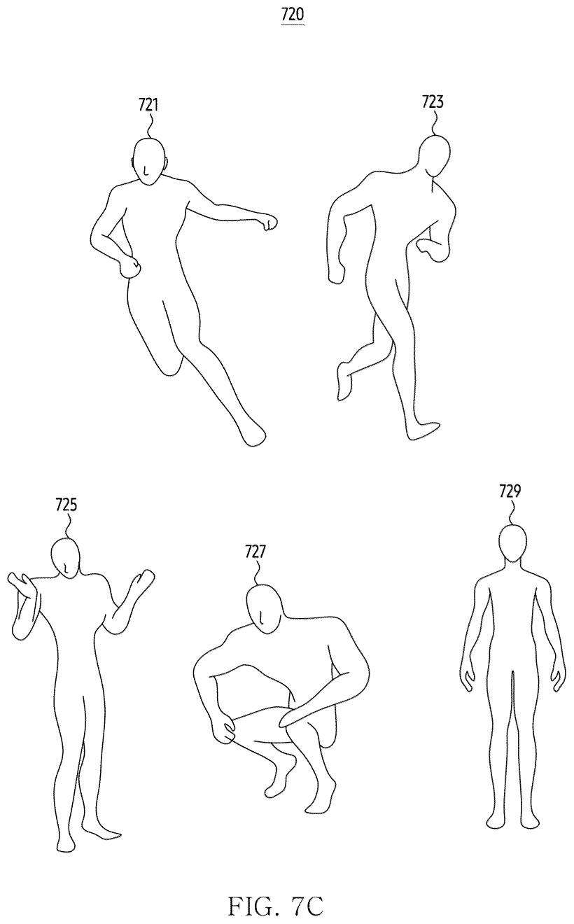

FIG. 7A illustrates an example 700 of sampling of hit reaction data according to embodiments. Data sampling describes in an embodiment, a process of extracting partial data from entire data. Resource efficiency may be increased by learning extracted partial data instead of learning the entire data. In order to output a more accurate result, selection of partial data that is suitable for a purpose is required.

Referring to FIG. 7A, the electronic device 210 according to embodiments may identify data for learning through sampling, instead of the entire data for a hit reaction.

The electronic device 210 may generate hit reaction data 701 for efficient learning of the adaptive hit reaction neural network. Thereafter, the electronic device 210 may obtain training data 703 through sampling of the hit reaction data 701.

According to an embodiment, the electronic device 210 may perform sampling based on whether an amount of change in a hit initial posture of an object is equal to or greater than a reference value. For example, the electronic device 210 may perform sampling to remove hit reaction data in which the amount of change in the hit initial posture of the object less than the reference value. When the amount of change in an initial posture is less than the reference value, this is because effectiveness of the data for hit reaction learning may be seen as relatively low.

According to an embodiment, the electronic device 210 may perform sampling based on whether an amount of change in an attack range is equal to or greater than a reference value. For example, the electronic device 210 may perform sampling to remove hit reaction data in which the amount of change in the attack range of the object is less than the reference value. When the amount of change in the attack range is less than the reference value, this is because effectiveness of the data for hit reaction learning may be seen as relatively low.

According to an embodiment, the electronic device 210 may perform sampling based on whether an amount of change in an attack part is equal to or greater than a reference value. For example, the electronic device 210 may perform sampling to remove hit reaction data in which the amount of change in the attack part of the object is less than the reference value. When the amount of change in the attack part is less than the reference value, this is because effectiveness of the data for hit reaction learning may be seen as relatively low.

According to an embodiment, the electronic device 210 may perform sampling based on whether an amount of change in a hit reaction is equal to or greater than a reference value. For example, the electronic device 210 may perform sampling to remove hit reaction data in which the amount of change in the hit reaction of the object is less than the reference value. When the amount of change in the hit reaction is less than the reference value, this is because effectiveness of the data for hit reaction learning may be seen as relatively low.

The electronic device 210 may perform sampling based on a parameter related to at least one of the initial posture, the attack range, the attack part, and the hit reaction, and obtain the training data 703. A loss of a neural network output result may be reduced by training neural network with the training data 703 in which sampling is completed. A reduction of a loss value the neural network output result may mean that accuracy of hit reaction outputted by the neural network increases.

FIG. 7B illustrates an example 710 of sampling based on an amount of change of hit reaction data according to embodiments. Referring to FIG. 7B, an example of a hit reaction to an algorithm for removing hit reaction data having an amount of change less than or equal to a reference value among sampling methods for the hit reaction data is illustrated.

The electronic device 210 may remove the hit reaction data having the amount of change less than or equal to the reference value from training data, for efficiency of neural network learning. For example, an operation state 711, an operation state 713, and an operation state 715 are hit reaction data for an operation of attacking a jaw. Herein, the hit reaction may include an operation in which the jaw of the object faces backward and the object falls. When the hit reaction data for the operation of attacking the jaw is secured in the electronic device 101, a hit reaction corresponding to the operation state 711, the operation state 713, and the operation state 715 has the amount of change less than or equal to the reference value, and thus the operation state 711, the operation state 713, and the operation state 715 may be removed from the training data. When the amount of change in the hit reaction is less than the reference value, this is because validity of corresponding data for hit reaction learning may be seen as relatively low.

FIG. 7C illustrates an example 720 of sampling based on an initial posture of hit reaction data according to embodiments.

Referring to FIG. 7C, an example of the initial posture to an algorithm of removing hit reaction data for the initial posture having an amount of change less than or equal to a reference value among sampling methods for the hit reaction data is illustrated.

An operation state 721, an operation state 723, an operation state 725, an operation state 727, and an operation state 729, which are states immediately before an object is hit, are illustrated through FIG. 7C. The operation state 721 may be a posture of circling while running, the operation state 723 may be a running posture, the operation state 725 may be a shrugging posture, the operation state 727 may be a squatting posture. The operation state 729 may be a standing posture.

The electronic device 210 (e.g., the processor 250) may remove hit reaction data in which a posture immediately before a hit has an amount of change less than or equal to a reference value from training data, for efficiency of neural network learning. For example, since there is a lot of hit reaction data in which the posture immediately before the hit is a standing posture in the training data, the operation state 729 in which the posture immediately before the hit is the standing posture may be removed from the training data. In case that a reference value is set high because there is a lot of hit reaction data in which the posture immediately before the hit is a standing posture in the training data, the operation state 725 may be removed from the training data by the operation state 725 being treated as a standing posture. In case that the reference value is set low, the operation state 725 may be included in the training data, by being treated as not being the standing posture.

When the amount of change in the initial posture is less than the reference value, this is because validity of the data for hit reaction learning may be seen as relatively low.

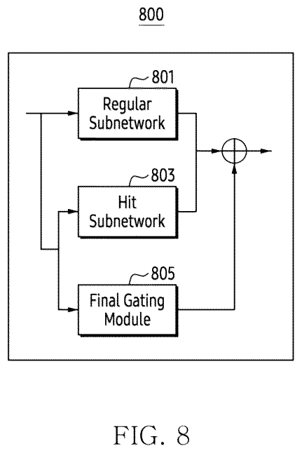

FIG. 8 illustrates an example of an adaptive hit reaction neural network according to embodiments. A hit reaction neural network is a neural network for generating a hit reaction. FIG. 8 illustrates a structure of the adaptive hit reaction neural network 309 of FIG. 3. In FIG. 8, sub-neural networks of the hit reaction neural network are described.

Referring to FIG. 8, an adaptive hit reaction neural network 800 may include an object operation learning neural network 801 and a hit reaction learning neural network 803. According to an embodiment, an electronic device 210 may train (503) the object operation learning neural network 801 for learning all operations of an object with first training data. The electronic device 210 may train 511 the hit reaction learning neural network 803 for learning a hit reaction of an object with second training data. The second training data may be obtained by sampling (507) hit reaction data 505 generated based on raw data. As a neural network dedicated to learning of a hit reaction data is separately equipped, the electronic device 210 may efficiently perform the learning of the hit reaction. The first training data may be general motion capture data as well as the hit reaction data.

The adaptive hit reaction neural network 800 may include a gating module 805. The gating module 805 may be a module for determining a final output for a hit reaction, based on an output of the object operation learning neural network 801 and an output of the hit reaction learning neural network 803. For example, the adaptive hit reaction neural network 800 may generate a hit reaction result by considering a first output of the object operation learning neural network 801, a first weight assigned to the first output, a second output of the hit reaction learning neural network 803, and a second weight assigned to the second output. Herein, an assignment of the first weight (e.g., a value greater than or equal to 0) and an assignment of the second weight (e.g., a value greater than or equal to 0) may be performed by the gating module 805. The gating module 805 may receive a hit condition as input data and provide a weight assigned to the output of the object operation learning neural network 803 and the output of the hit reaction learning neural network 801 to the adaptive hit reaction neural network 800.

According to an embodiment, the gating module 805 may determine the weight assigned to the output of the object operation learning neural network 801 and the output of the hit reaction learning neural network 803 based on hit intensity. For example, as the hit intensity is stronger, the weight assigned to the output of the hit reaction learning neural network 803 may be determined to be higher. When an object is attacked on a shoulder, as the hit intensity is lower, the gating module 805 may assign a higher weight to the output of the object operation learning neural network 801 than the output of the hit reaction learning neural network 803. In this case, magnitude of an operation of motion of not falling even when attacked on a shoulder and flailing may be reduced in the hit reaction.

The hit reaction neural network of FIG. 8 may be connected to components of FIG. 3. Referring to FIGS. 3 and 5, the adaptive hit reaction neural network 800 may include the object operation learning neural network 801 and the hit reaction learning neural network 803. According to an embodiment, the electronic device 210 may train the object operation learning neural network 801 for learning of all operations of an object with first training data (e.g., the operation 503 of FIG. 5). The electronic device 210 may train the hit reaction learning neural network 803 for learning of a hit reaction of an object with second training data (e.g., the operation 511 of FIG. 5). The second training data may be obtained through sampling from the hit reaction data 505 generated based on raw data. The first training data may include general motion capture data as well as the hit reaction data. Meanwhile, the second training data may be data sampled from the hit reaction data.

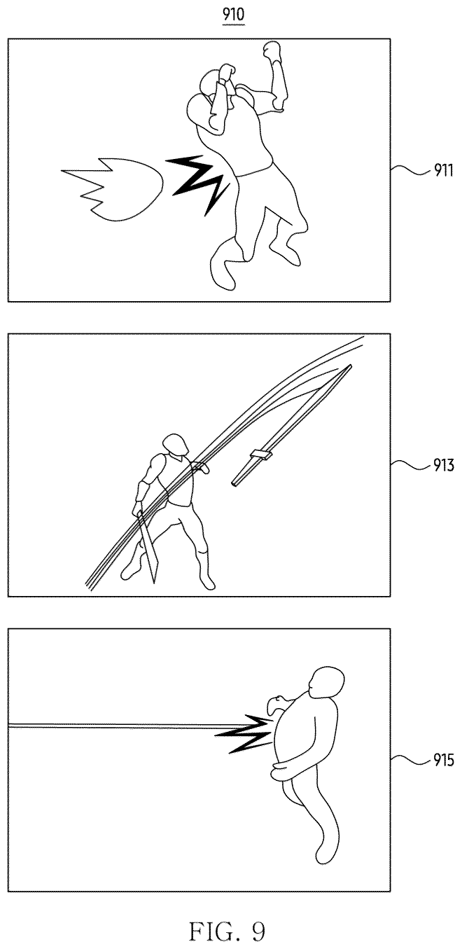

FIG. 9 illustrates examples 910 of a hit reaction according to embodiments. The hit reaction may vary according to a hit condition and an attack condition. The attack condition may include an attack means. FIG. 9 illustrates examples of a hit reaction according to the attack means among the attack condition.

Referring to FIG. 9, an operation state 901 indicates a state of an object being hit by kickboxing. An operation state 903 indicates a state of an object being hit by a sword. An operation state 905 indicates a state of an object being hit by a gun. It may be confirmed that various hit reactions may be obtained by using the present invention.

TABLE 1

| Example | Data size(s) | Action types |
|---|---|---|
| Gun | 2,484 | idle, walk, hit |
| Kickboxing | 256 | idle, walk, run, turn, |
| | | dodge, punch, kick, hit |
| Sword | 2,021 | idle, walk, run, turn, |
| | | swing, hit |

Table 1 indicates various hit reaction types (action type) and a hit reaction data size according to an attack condition (example). An object hit by a gun indicates three types of hit reactions. An object hit by kickboxing indicates eight types of hit reactions. An object hit by a sword indicates six types of hit reactions. That is, it may be confirmed that a type of hit reactions varies according to an attack means. Additionally, through Table 1, it may be confirmed that the hit reaction data size varies for each type of attack means.

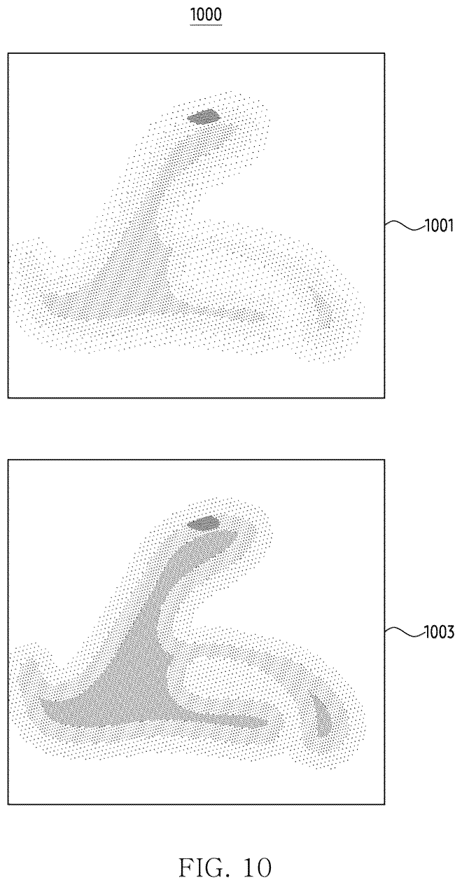

FIG. 10 illustrates an example 1000 of a comparison according to whether or not sampling hit reaction data according to embodiments.

Referring to FIG. 10, a graph 1001 indicates an average loss value of a neural network when hit in case that a data sampling method for hit reaction data is not performed. A graph 1003 indicates an average loss value of a neural network when hit in case that the data sampling method for the hit reaction data is performed. In the graph 1001 and the graph 1003, each point indicates an average loss value of a network for 10 frames after a hit occurs in a specific hit posture. It means that the lighter a color of the area, the greater a loss. A large loss means that learning of the neural network was not performed sufficiently. When the data sampling is performed, it may be confirmed that the average loss value of the neural network is relatively small compared to a case where the data sampling is not performed. Therefore, an effect of learning of the adaptive hit response neural network of the present disclosure may be further maximized through data sampling described through FIGS. 7A to 7C.

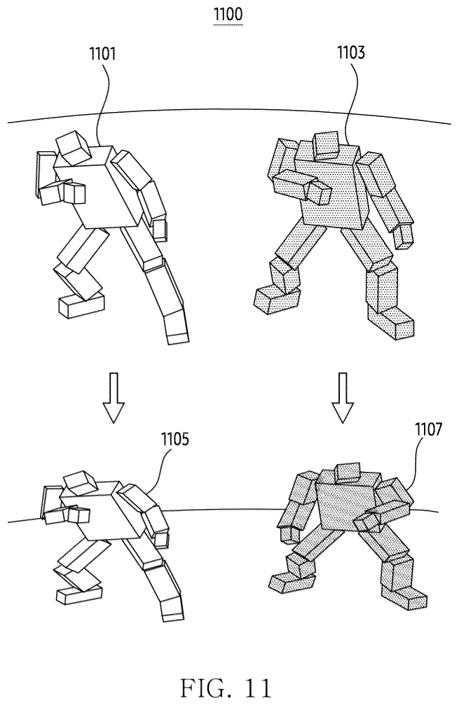

FIG. 11 illustrates an example 1100 of performance improvement of an adaptive hit reaction neural network according to embodiments. In FIG. 11, a hit reaction in a situation using an adaptive hit response neural network according to embodiments is compared with a hit reaction in a situation not using the adaptive hit reaction neural network.

Referring to FIG. 11, an operation state 1101 is a state before being hit based on a single neural network, an operation state 1103 is a state before being hit based on the adaptive reaction neural network, an operation state 1105 is a state after being hit based on the single neural network, and an operation state 1107 is a state after being hit based on the adaptive reaction neural network.

In case of the operation state 1105 in which a neural network structure is single, a posture before and after an attack does not change significantly. On the other hand, in case of the operation state 1107 in which the neural network structure is configured as a hit reaction learning neural network and an object operation learning neural network, a difference in detail of the posture before after the attack may be confirmed. This means that learning of neural network is improved due to a change in the neural network structure according to an embodiment.

When a neural network learns with a large amount of training data, the neural network may generate a natural hit reaction. However, a problem is that a resource is insufficient. In particular, due to finiteness of a temporal resource, a hit reaction generation speed is a major issue in an online game. When the adaptive hit reaction neural network according to embodiments of the present disclosure is used, a processor may efficiently generate a hit operation with a limited resource. Another problem is that it is difficult to synthesize a hit reaction operation on an arbitrary condition from hit reaction data on a limited condition. The present invention may generate an appropriate hit reaction operation according to an arbitrary attack condition. In particular, the processor may also synthesize reaction operations for secondary or higher multiple hits, which are difficult to synthesize through motion capture. The present invention may enhance consistency and richness in generated imagery.

As described above, a computer-readable storage medium according to an embodiment may store one or more programs, the one or more programs may include instructions that, when executed by a processor of an electronic device, cause the electronic device to provide to a first neural network for training operations of an object, first training data, identify second training data, by performing data sampling regarding hit reaction data, provide to a second neural network for training a hit reaction of the object, the second training data, and obtain a result of the hit reaction of the object, in case that the object is hit based on an output of the first neural network and an output of the second neural network.

For example, the one or more programs may include further instructions that, when executed by the processor of the electronic device, cause the electronic device to generate the hit reaction data, and for the hit reaction data to include instant hit reaction data according to force applied to the object, and subsequent hit reaction data according to an input of the object.

For example, the one or more programs may include instructions that, when executed by the processor of the electronic device, cause the electronic device to perform the data sampling based on an algorithm to remove hit reaction data of which an amount of change is equal to or less than a reference value, in order to identify the second training data.

For example, the one or more programs may include instructions that, when executed by the processor of the electronic device, cause the electronic device to include an amount of change for at least one of an initial posture, a hit part, a hit range, and hit intensity.

For example, the one or more programs may include instructions that, when executed by the processor of the electronic device, cause the electronic device to include a process for performing the data sampling based on an algorithm to remove hit reaction data regarding at least one of an initial posture, an attacked part, an attacked range, and/or attack intensity with an amount of change being equal to or less than a reference value, in order to identify the second training data.

For example, the one or more programs may include instructions that, when executed by the processor of the electronic device, cause the electronic device to obtain a result of the hit reaction of the object, in case that the object is hit based on an output of the first neural network and an output of the second neural network.

For example, the second neural network may be activated in case of identifying an attacking operation of another object from the second training data.

For example, the second neural network may be activated in case of hit intensity being equal to or greater than a reference value from the second training data.

As described above, a method of the electronic device according to an embodiment may comprise providing to a first neural network for training operations of an object, first training data, identifying second training data, by performing data sampling regarding hit reaction data, providing to a second neural network for training a hit reaction of the object, the second training data, and obtaining a result of the hit reaction of the object, in case that the object is hit based on an output of the first neural network and an output of the second neural network.

For example, a method of the electronic device according to an embodiment may comprise generating the hit reaction data, and the hit reaction data being generated based on instant hit reaction data according to force applied to the object, and subsequent hit reaction data according to an input of the object.

For example, a method of identifying the second training data according to an embodiment may comprise performing the data sampling based on an algorithm to remove hit reaction data of which an amount of change is equal to or less than a reference value.

For example, the amount of change according to an embodiment may include an amount of change for at least one of an initial posture, a hit part, a hit range, and hit intensity.

For example, identifying the second training data according to an embodiment may comprise performing the data sampling based on an algorithm to remove hit reaction data regarding at least one of an initial posture, an attacked part, an attacked range, and/or attack intensity with an amount of change being equal to or less than a reference value.

For example, a method of the electronic device according to an embodiment may comprise obtaining a result of the hit reaction of the object, in case that the object is hit based on an output of the first neural network and an output of the second neural network.

For example, the second neural network may be activated in case of identifying an attacking operation of another object from the second training data.

For example, the second neural network may be activated in case of a hit intensity being equal to or greater than a reference value from the second training data.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

As described above, although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

What is claimed is:

1. A computer readable storage medium, storing one or more programs including instructions that, when executed by a processor of an electronic device, cause the electronic device to:
provide first training data to a first neural network for training operations of an object,
identify second training data, by performing data sampling regarding hit reaction data,
provide the second training data to a second neural network for training a hit reaction of the object, and
obtain a result of the hit reaction of the object, in case that the object is hit, the result being based on an output of the first neural network and an output of the second neural network.

2. The computer readable storage medium of claim 1, wherein the one or more programs further includes instructions that, when executed by the processor of the electronic device, cause the electronic device to:
generate the hit reaction data, and
wherein the hit reaction data comprises instant hit reaction data based on a force applied to the object, and subsequent hit reaction data based on an input of the object.

3. The computer readable storage medium of claim 1, wherein the one or more programs further includes instructions that, when executed by the processor of the electronic device, cause the electronic device to:
in order to identify the second training data, perform the data sampling based on an algorithm to remove hit reaction data of which an amount of change is equal to or less than a reference value.

4. The computer readable storage medium of claim 1, wherein the one or more programs further includes instructions that, when executed by the processor of the electronic device, cause the electronic device to:
in order to identify the second training data, include a process for performing the data sampling based on an algorithm to remove hit reaction data regarding at least one of an initial posture, an attacked part, an attacked range, and/or attack intensity with an amount of change being equal to or less than a reference value.

5. The computer readable storage medium of claim 1, wherein the one or more programs further includes instructions that, when executed by the processor of the electronic device, cause the electronic device to:
obtain the result of the hit reaction of the object, in case that the object is hit based on a gating module for determining a weight assigned to the output of the first neural network and a weight assigned to the output of the second neural network.

6. The computer readable storage medium of claim 1, wherein the second neural network is activated in case of identifying an attacking operation of another object from the second training data.

7. The computer readable storage medium of claim 1, wherein the second neural network is activated in case of the hit intensity being equal to or greater than a reference value from the second training data.

8. A method executed by an electronic device comprising:
providing first training data to a first neural network for training operations of an object,
identifying second training data, by performing data sampling regarding hit reaction data,
providing the second training data to a second neural network for training a hit reaction of the object, and
obtaining a result of the hit reaction of the object, in case that the object is hit, the result being based on an output of the first neural network and an output of the second neural network.

9. The method of claim 8, further comprising:
generating the hit reaction data, and
wherein the hit reaction data is generated based on instant hit reaction data according to force applied to the object, and subsequent hit reaction data according to an input of the object.

10. The method of claim 8, wherein identifying the second training data comprises:
performing the data sampling based on an algorithm to remove hit reaction data of which an amount of change is equal to or less than a reference value.

11. The method of claim 8, wherein identifying the second training data comprises:
performing the data sampling based on an algorithm to remove hit reaction data regarding at least one of an initial posture, an attacked part, an attacked range, and/or attack intensity with an amount of change being equal to or less than a reference value.

12. The method of claim 8, further comprising:
obtaining a result of the hit reaction of the object, in case that the object is hit based on an output of the first neural network and an output of the second neural network.

13. The method of claim 8, wherein the second neural network is activated in case of identifying an attacking operation of another object from the second training data.

14. The method of claim 8, wherein the second neural network is activated in case of hit intensity being equal to or greater than a reference value from the second training data.
